(19) United States
(12) Patent Application Publication
(10) Pub. No.: US 2020/0028159 A1
(43) Pub. Date: Jan. 23, 2020

(54) CARBON-LITHIUM COMPOSITE POWDER AND PREPARATION METHOD THEREOF, AND PREPARATION METHOD OF LITHIUM METAL SECONDARY BATTERY ELECTRODE

(71) Applicant: Shandong Industrial Technology Research Institute of Zhejiang University, Zaozhuang City (CN)

(72) Inventors: Jiangping TU, Kunming City (CN); Sufu LIU, Kunming City (CN); Xiuli WANG, Kunming City (CN); Xinhui XIA, Kunming City (CN); Changdong GU, Kunming City (CN); Donghuang WANG, Kunming City (CN)

(73) Assignee: Shandong Industrial Technology Research Institute of Zhejiang University, Zaozhuang City (CN)

(21) Appl. No.: 16/146,136

(22) Filed: Sep. 28, 2018

(30) Foreign Application Priority Data
Jul. 17, 2018 (CN) 201810785831.2

(51) Int. Cl. H01M 4/36; H01M 10/052; H01M 4/62; H01M 10/0565; C01B 32/312; H01M 4/04

(52) U.S. Cl. CPC H01M 4/364; H01M 10/052; H01M 4/0404; H01M 10/0565; C01B 32/312; H01M 4/628

(57) ABSTRACT

The present invention provides a carbon-lithium composite powder and a preparation method thereof. In the present invention, a carbon material is used as a skeleton to support metal lithium, which increases the specific surface area of the composite powder, and can effectively reduce the current density and stabilize the surface potential of an electrode, thereby effectively inhibit the growth of lithium dendrites during the process in which the metal lithium is used as an anode material. The present invention provides a method for preparing a lithium metal secondary battery electrode. In the present invention, a roller-press flaking process is adopted to prepare the electrode, such that it is easy to regulate the effective capacity of the metal lithium loaded on the current collector, thereby better matching the corresponding active cathode material to improve the effective utilization rate of the metal lithium.

This application claims priority to Chinese patent application number 201810785831.2, filed Jul. 17, 2018, with a title of CARBON-LITHIUM COMPOSITE POWDER AND PREPARATION METHOD THEREOF, AND PREPARATION METHOD OF LITHIUM METAL SECONDARY BATTERY ELECTRODE. The above-mentioned patent application is incorporated herein by reference in its entirety.

### TECHNICAL FIELD

The present invention belongs to the technical field of lithium metal secondary batteries, and in particular relates to a carbon-lithium composite powder and a preparation method thereof and a preparation method of a lithium metal secondary battery electrode.

### BACKGROUND

Although the graphite anode shows an excellent safety performance and cycle stability, it can no longer meet the application requirements of an electric vehicle for long endurance since it only has a theoretically reversible capacity of 372 mAh/g and it is difficult for the full battery energy density to exceed 260 Wh/kg theoretically. The Li metal anode has the lowest density (0.59 g/cm³) and lowest electrochemical potential (3.04 V) of the metal family, and has a theoretical specific capacity reaching up to 3,860 mAh/g. Lithium metal secondary batteries, including lithium-sulfur batteries, lithium-air batteries and lithium-oxide batteries, all show extremely high theoretical energy density (lithium-air batteries: 3,500 Wh/kg, lithium-sulfur batteries: 2,600 Wh/kg, and lithium-oxide batteries: 1,000-1,500 Wh/kg). The excellent performance of lithium metal secondary batteries provides a new way to realize high energy-density energy storage devices.

Although the metal lithium has great potential in the field of electrochemical energy storage, the commercial application of lithium metal secondary batteries has never been realized. Basically, there are three main problems of using the metal lithium as anode: the high activity of the metal lithium leads to a series of non-faradaic reactions between the metal lithium and electrolyte, which reduces the Coulombic efficiency during charging-discharging cycles; and meanwhile, these reaction products accumulate continuously on the surface of the metal lithium electrode, thus increasing the interface impedance, hindering the transfer of lithium ions in the electrode interface layer, causing an increased electrode polarization and even battery failure; such that the effective utilization rate of lithium metal in the secondary battery is ultralow, which limits the development of the lithium metal secondary battery.

### SUMMARY

In view of this, the present invention provides a carbon-lithium composite powder and a preparation method thereof, and a preparation method of a lithium metal secondary battery electrode. The effective utilization rate of lithium metal is high, and dendrites can be effectively inhibited when the composite powder provided by the present invention is used for preparing an anode material.

To achieve the above object, the present invention provides the following technical solutions:

The present invention provides a carbon-lithium composite powder, which includes a carbon skeleton and metal lithium coated on the surface of the carbon skeleton in composition.

Preferably, the particle size of the composite powder is 500 nm to 50 μm.

The mass ratio of the carbon skeleton to the metal lithium in the composite powder is (10-90):(10-90); and the components of the carbon skeleton include one or more of mesoporous carbon, activated carbon and graphene.

Preferably, the carbon skeleton further contains a doping source, and the mass of the doping source is 0.05% to 0.5% of the mass of the carbon skeleton; and the doping source is one or more of nitrogen, sulfur and phosphorus.

The present invention provides a method for preparing the carbon-lithium composite powder described in the above technical solution, which includes the steps of:

(1) heating a mixture including a carbon material and metal lithium to 250-400° C., then stirring at a constant temperature, and subsequently cooling to obtain a primary coated powder, where the time of the constant-temperature stirring is 5-40 min, and the rotation speed of the constant-temperature stirring is 50-200 r/min;

and

(2) ball milling the primary coated powder obtained in step (1) to obtain the carbon-lithium composite powder.

Preferably, the ball milling time in step (2) is 0.5-2 h, and the rotation speed of the ball milling is 50-400 r/min.

Preferably, the particle size of the carbon material in step (1) is 200 nm to 30 μm.

Preferably, before mixing the carbon material with the metal lithium, the method further includes: performing doping modification on the carbon raw material to obtain a doped carbon material; and the element used for doping modification is preferably one or more of nitrogen, sulfur and phosphorus.

The present invention further provides a method for preparing a lithium metal secondary battery electrode, which includes the steps of: coating a PET film and carbon-lithium composite powder onto the surface of a current collector in a roll-pressing manner to obtain the lithium metal secondary battery electrode; or coating a gel electrolyte and the carbon-lithium composite powder onto the surface of the current collector in a roll-pressing manner to obtain the lithium metal secondary battery electrode.

Preferably, the gel electrolyte is polyoxyethylene-bis(trifluoromethane)sulfonimide lithium, PVDF-poly(vinylidene fluoride-co-hexafluoropropylene)-Li₇La₃Zr₂O₁₂, or PVDF-poly(vinylidene fluoride-co-hexafluoropropylene)-Li₁₃Ti_{1.7}Al_{0.3}(PO₄)₃; and the mass of the gel electrolyte is less than or equal to 1% of the mass of the carbon-lithium composite powder.

Preferably, based on the mass of the carbon-lithium composite powder, the coating amount is 0.2-20 mg/cm².

The present invention provides a carbon-lithium composite powder, which includes a carbon skeleton and metal lithium coated on the surface of the carbon skeleton in composition. In the present invention, a carbon material is used as a skeleton to realize support for the metal lithium, which improves the specific surface area of the composite powder, effectively reduces the current density, and stabilizes the surface potential of the electrode, thereby effectively inhibiting the growth of lithium dendrites during the process in which the metal lithium is used as the anode material, and preventing reduction of battery capacity caused by falling off of the lithium metal from the anode material; and it also can prevent thermal runaway and even explosion of the battery caused by internal short circuit due to the pierced separator by growth of lithium dendrites.

The present invention also provides a method for preparing a carbon-lithium composite powder. In the present invention, a lithium-carbon alloy phase of LiₓC is formed by alloying of a carbon material and metal lithium during a stirring process at a constant temperature, the alloy phase mainly functions for the wettability of liquid metal lithium and generates a relatively larger chemical acting force. And under the alloying force, the surface of the carbon material adsorbs molten lithium; and meanwhile, the wettability of the surface of the carbon material is enhanced by means of the microporous capillary action on the surface of the carbon material, and under the action of a stirring force, the molten lithium is uniformly coated on the surface of the carbon material, so that the carbon material functions for supporting the metal lithium.

The present invention provides a method for preparing a lithium metal secondary battery electrode. In the present invention, a roller-press flaking process is adopted to prepare the electrode, such that it is easy to regulate the effective capacity of the metal lithium loaded on the current collector, thereby better matching the corresponding active cathode material to improve the effective utilization rate of the metal lithium.

The results of the embodiments show that, the utilization rate of lithium in the lithium metal secondary battery electrode prepared by the carbon-lithium composite powder of the present invention reaches 20%-50%, and no lithium dendrite is generated.

### BRIEF DESCRIPTION OF THE DRAWINGS

The present invention will be further described in detail with reference to the accompanying drawings and specific embodiments.

FIG. 1 is a schematic diagram of the preparation process of a carbon-lithium composite powder prepared by the present invention;

FIG. 2 is a schematic diagram of the roller-press preparation of the lithium metal secondary battery electrode of the present invention;

FIG. 3 is an SEM image of the carbon-lithium composite powder obtained in Embodiment 1;

FIG. 4 is an SEM image of the carbon-lithium composite powder obtained in Embodiment 3;

FIG. 5 is the SEM comparative images of the carbon-lithium composite powder obtained in Embodiment 3 and a pure lithium foil after 50 cycles at a current density of 1 mA cm⁻².

### DETAILED DESCRIPTION

The present invention provides a carbon-lithium composite powder, which includes a carbon skeleton and metal lithium coated on the surface of the carbon skeleton in composition. In the present invention, the particle size of the composite powder is preferably 500 nm to 50 μm, further preferably 800 nm to 40 μm, and more preferably 1,000 nm to 20 μm.

In the present invention, the carbon-lithium composite powder includes a carbon skeleton and metal lithium coated on the surface of the carbon skeleton in composition; and the carbon skeleton and the metal lithium are bonded through an alloying action force. In the present invention, the mass ratio of the carbon skeleton to the metal lithium is preferably (10-90):(10-90), and further preferably (20-80):(20-80); and it may be specifically 10:90, 20:80, 30:70, 50:50, 60:40 or 80:20 in the embodiments of the present invention.

In the present invention, the components of the carbon skeleton includes one or more of mesoporous carbon, activated carbon and graphene; and the activated carbon is preferably biomass activated carbon, and further preferably includes carbonized loofah sponge carbon, rice carbon, cotton carbon, chestnut shell carbon or bamboo carbon. In the present invention, the particle size of the carbon skeleton is preferably 500 nm to 50 μm, further preferably 800 nm to 40 μm, and more preferably 1,000 nm to 20 μm. In the present invention, the carbon skeleton is a micro-nano carbon material, has stable non-electrochemical activity, and functions for supporting the metal lithium; and the internal carbon skeleton structure is beneficial for construction of a lithium metal nucleation site, which can improve the uniform deposition of lithium ions, and meanwhile the high specific surface area of the carbon skeleton can effectively reduce the current density to inhibit the growth of lithium dendrites, thereby facilitating stabilization of the surface potential of the electrode and improvement of the stability of the electrode.

In the present invention, the carbon skeleton preferably further contains a doping source. The mass of the doping source is preferably 0.05% to 0.5%, further preferably 0.1% to 0.45%, and more preferably 0.2% to 0.35% of the mass of the carbon skeleton; and the doping source is preferably one or more of nitrogen, sulfur and phosphorus. In the present invention, the existence of the doping source can construct more nucleation sites for the lithium metal, and regulate the uniform deposition of lithium ions, thereby further improving the stability of the anode material.

In the present invention, the high specific surface area of the carbon-lithium composite powder can effectively reduce the current density, and stabilizes the surface potential of the electrode, thereby effectively inhibiting the growth of lithium dendrites when used as the anode material, and preventing capacity decay caused by falling off of the dead lithium from the anode; and it also can prevent thermal runaway and even explosion of the battery caused by internal short circuit due to the pierced separator by growth of lithium dendrites.

The present invention also provides a method for preparing the carbon-lithium composite powder described in the above technical solution, which includes the steps of:

(1) heating a mixture including a carbon material and metal lithium to 250-400° C., then stirring at a constant temperature, and subsequently cooling to obtain primary coated powder, where the time of the constant-temperature stirring is 5-40 min, and the rotation speed of the constant-temperature stirring is 50-200 r/min; and

(2) ball milling the primary coated powder obtained in step (1) to obtain the carbon-lithium composite powder.

In the present invention, the mixture including the carbon material and the metal lithium is heated to 250-400° C., then stirred at a constant temperature, and subsequently cooled to obtain the primary coated powder.

In the present invention, the mass ratio of the carbon material to the metal lithium in the mixture is preferably (10-90):(10-90), and further preferably (20-80):(20-80); and it may be specifically 10:90, 20:80, 30:70, 50:50, 60:40 or 80:20 in the embodiments of the present invention.

In the present invention, the composition of the carbon material is the same as that of the carbon skeleton in the carbon-lithium composite powder described in the above technical solution, and thus will not be repeated anymore here. In the present invention, the particle size of the carbon material is preferably 200 nm to 30 μm, further preferably 500 nm to 20 μm, and more preferably 800 nm to 15 μm.

In the present invention, when the activated carbon is a biomass activated carbon, the preparation method of the biomass activated carbon preferably includes: sequentially carbonizing and ball milling a carbon raw material to obtain the carbon material. In the present invention, the carbonization temperature is preferably 600-1200° C., further preferably 800-1,000° C., and more preferably 850-900° C.; and the carbonization time is preferably 1-4 h, and further preferably 1.5-3 h. In the present invention, the carbon raw material is preferably one or more of loofah sponge carbon, rice carbon, cotton carbon, chestnut shell carbon, and bamboo carbon. In the present invention, during the carbonization process, the carbon raw material forms mesopores and micropores to increase the specific surface area of the carbon material. In the present invention, the rotation speed of the ball milling is preferably 100-400 r/min, further preferably 120-350 r/min, and more preferably 150-300 r/min; and the time of the ball milling is preferably 0.5-3 h, and further preferably 1-1.5 h. In the present invention, during the ball milling process, refining of the carbonized carbon raw material is achieved.

In the present invention, before mixing the carbon material with the metal lithium, the method further includes: performing doping modification on the carbon raw material to obtain a doped carbon material; and the element used for doping modification is preferably one or more of nitrogen, sulfur and phosphorus. The present invention preferably adopts a chemical vapor deposition method or an ion implantation method to perform doping modification on the carbon raw material; and the present invention has no special requirements on the specific implementation of the chemical vapor deposition method or the ion implantation method, and an implementation well known to those skilled in the art can be used.

In the present invention, the metal lithium is preferably a metal lithium foil; and the present invention has no special requirement on the size of the metal lithium foil.

In the present invention, the mixture is preferably heated to 200-400° C., and further preferably 260-350° C. under nitrogen; and in the present invention, the heating temperature is adjusted according to the type of carbon material contained in the mixture; where when the carbon material is mesoporous carbon, the heating temperature is preferably 340-360° C.; and when the carbon material is graphene, the heating temperature is preferably 230-270° C. In the present invention, when the carbon material is activated carbon, the heating temperature is preferably 280-400° C.; and when the carbon material is biomass activated carbon, the heating temperature is preferably 350-400° C. In the present invention, corresponding heating temperatures are set according to different carbon materials, which facilitates the improvement of the wettability and coating uniformity of the liquid metal lithium on different carbon materials.

The present invention has no special requirement on the time for heating to the target temperature, and a time well known to those skilled in the art can be adopted, as long as the target temperature can be obtained. In the present invention, the heating is specifically carried out in a high-temperature stirrer. In the present invention, during the heating process, the metal lithium is melted to obtain molten lithium.

In the present invention, after heated to the target temperature, the heated material is stirred at a constant temperature and then cooled to obtain the primary coated powder. In the present invention, the time of the constant-temperature stirring is 5-40 min, preferably 10-35 min, further preferably 12-30 min, and more preferably 15-20 min; and the rotation speed of the constant-temperature stirring is 50-200 r/min, preferably 80-150 r/min, and further preferably 100-120 r/min. In the present invention, the temperature of the constant-temperature stirring is the target temperature to which is heated. In the present invention, particularly the constant-temperature stirring is continually carried out in a high-temperature stirrer. In the present invention, during the constant-temperature stirring, a lithium-carbon alloy phase of LixC is formed by alloying of a carbon material and metal lithium during a stirring process at a constant temperature, the alloy phase mainly functions for the wettability of liquid metal lithium and generates a relatively larger chemical acting force. and under the alloying action force, the surface of the carbon material adsorbs molten lithium; and furthermore, a microporous capillary action also exists on the surface of the carbon material to improve the wettability of the surface of the carbon material, and under the action of a stirring force, the molten lithium is uniformly coated on the surface of the carbon material, so that the carbon material functions for supporting the metal lithium. In the present invention, after the constant-temperature stirring, cooling is conducted to solidify the liquid lithium coated on the surface of the carbon material, so as to obtain a crude product of the metal lithium composite powder supported by the carbon skeleton, i.e., the primary coated powder. The present invention has no special requirement on the cooling manner, and a manner well known to those skilled in the art can be used. In the present invention, the particle size of the primary coated powder is preferably 1-100 μm, further preferably 10-60 μm, and more preferably 30-50 μm; and the primary coated powder has various shapes, which may be spherical, lamellar, tubular or linear.

In the present invention, after the primary coated powder is obtained, the primary coated powder is subjected to ball milling to obtain the carbon-lithium composite powder. In the present invention, the time of ball milling is preferably 0.5-2 h, further preferably 0.6-1.5 h, and more preferably 1.0-1.2 h; and the rotation speed of the ball milling is preferably 50-400 r/min, further preferably 100-350 r/min, and more preferably 120-300 r/min. In the present invention, during the ball milling of the primary coated powder, not only the refinement of the powder is realized, but also the particle size uniformity of the powder can be improved.

In the present invention, after the ball milling, preferably the ball-milled powder passes through a 280-12,500 mesh screen, and the screen underflow is used as the carbon-lithium composite powder; and the mesh size for screening is further preferably 500-10,000 mesh, and more preferably 1,200-7,500 mesh.

The present invention provides a method for preparing a lithium metal secondary battery electrode, which includes the steps of: coating a PET film and a carbon-lithium composite powder onto the surface of a current collector in a roll-pressing manner to obtain the lithium metal secondary battery electrode; or coating a gel electrolyte and the carbon-lithium composite powder onto the surface of the current collector in a roll-pressing manner to obtain the lithium metal secondary battery electrode.

In the present invention, the gel electrolyte and the carbon-lithium composite powder are coated on the surface of the current collector in a roll-pressing manner to obtain the lithium metal secondary battery electrode. In the present invention, the gel electrolyte is preferably polyoxyethylene (POE)-bis(trifluoromethane)sulfonimide lithium (LiTFSI), PVDF-Li7La₃Zr₂O₁₂ (LLZO) or PVDF-poly(vinylidene fluoride-co-hexafluoropropylene)-Li₁₃Ti_{1.7}Al_{0.3}(PO₄)₃ (LATP); and when the gel electrolyte is a mixture, the present invention has no special requirement on the components of the mixture, and the components can be mixed in any proportion. The present invention has no special requirement on the particular source of the gel electrolyte, and a commercially available product well known to those skilled in the art can be used. In the present invention, the mass of the gel electrolyte preferably is less than or equal to 1% of the mass of the carbon-lithium composite powder, and further preferably is 0.1-0.8% of the mass of the carbon-lithium composite powder.

In the present invention, the roll-pressing manner is preferably placing the carbon-lithium composite powder on the surface of the current collector, and then using a twin roller to cover a gel electrolyte film on the carbon-lithium composite powder while realizing pressing. In the present invention, the current collector is preferably a copper foil current collector; and the present invention has no special requirement on the size of the current collector, and a size well known to those skilled in the art can be used. In the present invention, the carbon-lithium composite powder can be placed onto one or both of the two surfaces of the current collector; and based on the mass of the carbon-lithium composite powder, the coating amount is preferably 0.2-20 mg/cm², further preferably 0.3-15 mg/cm², and more preferably 0.5-10 mg/cm². The present invention has no special requirement on the manner of placing the carbon-lithium composite powder onto the surface of the current collector, and a manner well known to those skilled in the art can be used; and in the present invention, the roll-pressing pressure is preferably 5 MPa. The present invention has no special requirement on the specific implementation of roll-pressing, and a roll-pressing manner well known to those skilled in the art can be used. In the present invention, the roll-pressing manner is adopted to coat the gel composite powder onto the surface of the current collector, such that it can effectively regulate the loading capacity of the metal lithium on the surface of the current collector, and thus it is easy to regulate the effective capacity of the metal lithium loaded in the anode material, thereby better matching the corresponding active cathode material to improve the effective utilization rate of the metal lithium; and an anode material with a porous structure therein can be prepared. In the present invention, the porous structure of the anode material benefits from the porous structure of the carbon material in the carbon-lithium composite powder and also from the pores formed between the carbon-lithium composite powder during the roll-pressing process.

In the present invention, after the coating, preferably the coated current collector is directly roll-pressed to obtain the lithium metal secondary battery electrode.

In the present invention, the PET film and the carbon-lithium composite powder may also be coated onto the surface of the current collector in a roll-pressing manner to obtain the lithium metal secondary battery electrode. In the present invention, the mass of the PET film preferably is less than or equal to 1% of the mass of the carbon-lithium composite powder. The present invention has no special requirement on the particular source of the PET film, and a commercially available product well known to those skilled in the art can be used. In the present invention, the manner of obtaining the lithium metal secondary battery electrode by coating the PET film and the carbon-lithium composite powder onto the surface of the current collector is the same as that for obtaining the lithium metal secondary battery electrode by coating the gel electrolyte and the carbon-lithium composite powder onto the surface of the current collector, and thus will not be repeated anymore here.

The carbon-lithium composite powder and the preparation method thereof, and the preparation method of the lithium metal secondary battery electrode as provided by the present invention will be described in detail below in connection with the following Embodiments, but these Embodiments should not be understood as limiting the claimed scope of the present invention.

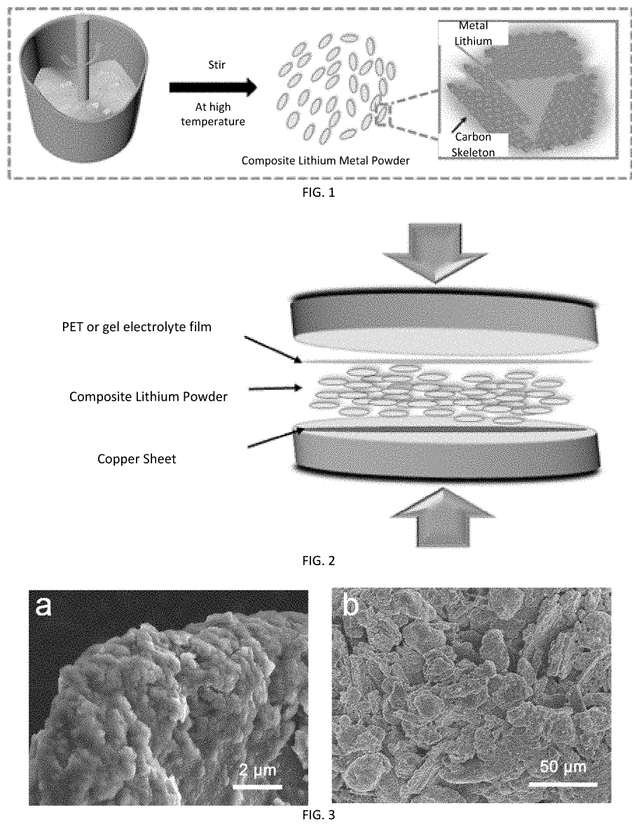

The schematic diagram showing the bonding of the carbon material and the metal lithium during the constant-temperature stirring in the following Embodiments is shown in FIG. 1; and the roll-pressing process of the lithium metal secondary battery electrode in the following Embodiments is carried out according to the process shown in FIG. 2.

### Embodiment 1

The activated carbon powder was pre-placed into a high energy ball milling tank for mechanical ball milling (at a rotating speed of 200 r/min for 1 h) to obtain the activated carbon powder with the particle size of 5 μm, and the activated carbon powder was taken out and ready for use.

Under a high-purity argon atmosphere, lithium metal of a battery-grade purity was cut into small pieces. According to the mass content of the metal lithium at the proportion of 70%, the lithium metal sheet was mixed with the active carbon powder, and placed together into a high-temperature stirrer, in which the metal lithium is molten when the temperature is heated to 300° C., and then maintained at a constant temperature under the mechanical stirring action of a stainless steel stirrer at a rotating speed of 100 r/min for 10 min. After the constant-temperature stirring was completed, the heat supply of the high-temperature stirrer was stopped to realize the solidification of the lithium melt so as to obtain the composite lithium metal powder; and the primarily obtained composite lithium metal powder was placed into a ball milling tank for mechanical ball milling (at a rotating speed of 100 r/min for 10 min), and screened (with the number of meshes being 1,250) to obtain the carbon-lithium composite powder with the particle size of 10 μm.

The composite powder was directly coated onto the surface of a copper foil current collector by adopting a dry powder coating process on the copper foil current collector while a PET film was covered, and then roll-pressed (the mass of the covered PET film was 0.5% of the mass of the carbon-lithium composite powder), to directly prepare a porous-structured composite lithium metal electrode supported by an activated carbon skeleton, where based on the coated carbon-lithium composite powder, the coating amount of PET-lithium carbon on the surface of the current collector was 0.74 mg/cm².

### Embodiment 2

The ordered mesoporous carbon powder was pre-placed into a high energy ball milling tank for mechanical ball milling (at a rotating speed of 250 r/min for 1.5 h) to obtain the mesoporous carbon powder with the particle size of 2 μm, and the mesoporous carbon powder was taken out and ready for use.

Under a high-purity argon atmosphere, lithium metal of a battery-grade purity was cut into small pieces. According to the mass content of the metal lithium at the proportion of 80%, the lithium metal sheet was mixed with the active carbon powder, and placed together into a high-temperature stirrer, in which the metal lithium is molten when the temperature is heated to 350° C., and then maintained at a constant temperature under the mechanical stirring action of a stainless steel stirrer at a rotating speed of 150 r/min for 30 min. After the constant-temperature stirring was completed, the heat supply of the high-temperature stirrer was stopped to realize the solidification of the lithium melt so as to obtain the composite lithium metal powder; and the composite lithium metal powder which was primarily obtained after the constant-temperature stirring was placed into a ball milling tank for mechanical ball milling (at a rotating speed of 150 r/min for 15 min), and screened (with the number of meshes being 2,500) to obtain the carbon-lithium composite powder with the particle size of 5 μm.

The composite powder was directly coated onto the surface of a copper foil current collector by adopting a dry powder coating process on the copper foil current collector while a PVDF-HFP-LLZO film was covered, and then roll-pressed (the mass of the covered PVDF-HFP-LLZO film was 1% of the mass of the carbon-lithium composite powder), to directly prepare a porous-structured composite lithium metal electrode supported by an ordered mesoporous carbon skeleton, where based on the coated carbon-lithium composite powder, the coating amount of PVDF-HFP-LLZO-lithium carbon on the surface of the current collector was 0.65 mg/cm².

### Embodiment 3

A loofah sponge is pre-carbonized (carbonized under a pure argon atmosphere at 900° C. for 2 h), and then the carbonized loofah sponge powder was placed into a high energy ball milling tank for mechanical ball milling (at a rotating speed of 300 r/min for 2 h) to obtain the activated carbon powder with the particle size of about 15 μm, and the activated carbon powder was taken out and ready for use.

Under a high-purity argon atmosphere, lithium metal of a battery-grade purity was cut into small pieces. According to the mass content of the metal lithium at the proportion of 60%, the lithium metal sheet was mixed with the active carbon powder, and placed together into a high-temperature stirrer, in which the metal lithium is molten when the temperature is heated to 400° C., and then maintained at a constant temperature under the mechanical stirring action of a stainless steel stirrer at a rotating speed of 200 r/min for 40 min. After the constant-temperature stirring was completed, the heat supply of the high-temperature stirrer was stopped to realize the solidification of the lithium melt so as to obtain the composite lithium metal powder; and the composite lithium metal powder which was primarily obtained after the constant-temperature stirring was placed into a ball milling tank for mechanical ball milling (at a rotating speed of 200 r/min for 20 min), and screened (with the number of meshes being 400) to obtain the carbon-lithium composite powder with the particle size of 30 μm.

The composite powder was directly coated onto the surface of a copper foil current collector by adopting a dry powder coating process on the copper foil current collector while a POE-LiTFSI film was covered, and then roll-pressed (the mass of the covered POE-LiTFSI film was 0.8% of the mass of the carbon-lithium composite powder), to directly prepare a porous-structured composite lithium metal electrode supported by a carbonized loofah sponge skeleton, where based on the coated carbon-lithium composite powder, the coating amount of POE-LiTFSI-lithium carbon on the surface of the current collector was 0.86 mg/cm².

### Embodiment 4

The activated carbon powder of bamboo charcoal fibers which were pre-carbonized (carbonized under a pure argon atmosphere at 800° C. for 2 h) was placed into a high energy ball milling tank for mechanical ball milling (at a rotating speed of 200 r/min for 1 h) to obtain the activated carbon powder with the particle size of 10 μm, and the activated carbon powder was taken out and ready for use.

Under a high-purity argon atmosphere, lithium metal of a battery-grade purity was cut into small pieces. According to the mass content of the metal lithium at the proportion of 50%, the lithium metal foil was mixed with the active carbon powder, and placed together into a high-temperature stirrer, in which the metal lithium is molten when the temperature is heated to 250° C., and then maintained at a constant temperature under the mechanical stirring action of a stainless steel stirrer at a rotating speed of 150 r/min for 20 min. After the constant-temperature stirring was completed, the heat supply of the high-temperature stirrer was stopped to realize the solidification of the molten lithium so as to obtain the lithium metal composite powder; and the lithium metal composite powder which was primarily obtained after the constant-temperature stirring was placed into a ball milling tank for mechanical ball milling (at a rotating speed of 150 r/min for 30 min), and screened (with the number of meshes being 500) to obtain the carbon-lithium composite powder with the particle size of 20 μm.

The composite powder was directly coated onto the surface of a copper foil current collector by adopting a dry powder coating process on the copper foil current collector while a PVDF-HFP-LATP film was covered, and then roll-pressed (the mass of the covered PVDF-HFP-LATP film was 0.8% of the mass of the carbon-lithium composite powder), to directly prepare a porous-structured lithium metal composite electrode supported by a bamboo charcoal fiber skeleton, where based on the coated carbon-lithium composite powder, the coating amount of PVDF-HFP-LATP-lithium carbon on the surface of the current collector was 1.04 mg/cm².

### Embodiment 5

The carbon-lithium composite powder and the lithium metal secondary electrode were prepared according to the manner used in Embodiment 1, except that the activated carbon powder was pre-doped with nitrogen by the following method: 140 mg of the activated carbon powder with the particle size of 5 microns was pre-dissolved in 70 ml of deionized water, ultrasonically stirred for 0.5 h, added with 0.3 g of thiourea, stirred until dissolved, hydrothermally reacted at 160° C. for 3 h, then filtered and dried to obtain an activated carbon material with a nitrogen doping amount of 0.5%. The subsequent steps were consistent with those in Embodiment 1, and a porous-structured lithium metal composite electrode supported by a nitrogen-doped activated carbon skeleton was directly prepared.

### Embodiment 6

A lithium metal composite electrode was prepared in the manner of Embodiment 1, except that the coating amount of the PET composite powder on the surface of the current collector was 1.85 mg/cm² based on the coated carbon-lithium composite powder.

### Embodiment 7

A lithium metal composite electrode was prepared in the manner of Embodiment 2, except that the coating amount of the gelatin composite powder on the surface of the current collector was 1.63 mg/cm² based on the coated carbon-lithium composite powder.

### Embodiment 8

A lithium metal composite electrode was prepared in the manner of Embodiment 3, except that the coating amount of the gelatin composite powder on the surface of the current collector was 2.15 mg/cm² based on the coated carbon-lithium composite powder.

### Embodiment 9

A lithium metal composite electrode was prepared in the manner of Embodiment 4, except that the coating amount of the gelatin composite powder on the surface of the current collector was 2.6 mg/cm² based on the coated carbon-lithium composite powder.

### Embodiment 10

A lithium metal composite electrode was prepared in the manner of Embodiment 5, except that the coating amount of the gelatin composite powder on the surface of the current collector was 1.85 mg/cm² based on the coated carbon-lithium composite powder.

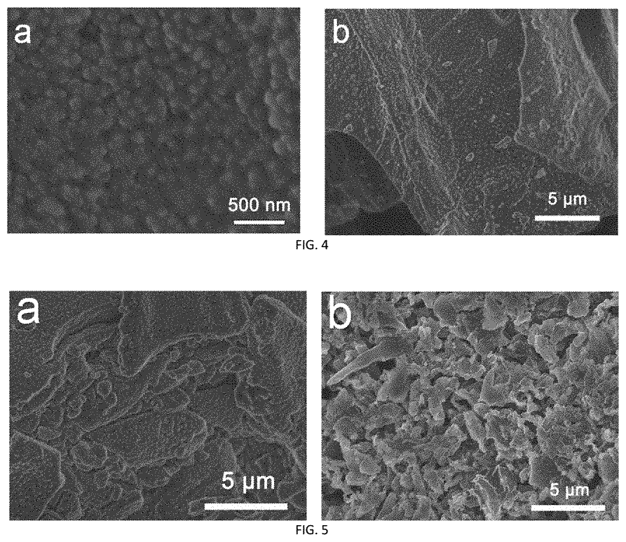

The carbon-lithium composite powder obtained in Embodiments 1 to 5 was subjected to SEM characterization, where the characterization result of Embodiment 1 was shown in FIG. 3, and the characterization result of Embodiment 3 was shown in FIG. 4. As could be seen from FIGS. 3 and 4, the metal lithium was well coated on the designed carbon skeleton, and the resultant carbon-lithium composite powder had a uniform particle size. The detection results of other Embodiments were similar to those of FIGS. 3 and 4. It could be seen from all of the Embodiments that, the metal lithium was well coated on the designed carbon skeleton, and the resultant carbon-lithium composite powder had a uniform particle size.

Performance Test

The lithium metal composite powder electrodes supported by the micro-nano carbon skeleton as prepared in the above Embodiments 1 to 5 were used respectively as counter electrodes and working electrodes of a button cell to test the performance of a symmetrical cell (the effective capacity of lithium metal composite electrode was controlled to be 2-5 mAh·cm⁻²), where the electrolyte solution was 1 mol/L bis(trifluoromethane)sulfonimide lithium (LiTFSI) electrolyte dissolved in 1,3-dioxolane (DOL) and ethylene glycol dimethyl ether (DME) with a volume ratio of 1:1, and the electrolyte contained LiNO₃ additive with a mass fraction of 1%. The current density was 1 mA·cm⁻² with a stripping/plating capacity of 1 mAh·cm⁻².

The change in cross section was measured by a scanning electron microscopy to evaluate the volume expansion ratio.

The performance test results were as follows:

The carbon-lithium composite powder electrodes obtained in Embodiments 1 to 5 had a metal lithium loading capacity of 2 mAh cm⁻². After the electrodes were cycled for 300 times at a current density of 1 mA cm⁻² with a cycling capacity of 1 mAh cm⁻² (i.e., having the effective utilization rate of the metal lithium of 50%), the overpotentials could be stabilized within 66 mV, 44 mV, 56 mV, 52 mV and 45 mV respectively, and the voltage platform was stable without obvious fluctuation. The volume expansion ratio could be controlled at 4%, 2%, 3%, 2% and 3% respectively.

Furthermore, the lithium metal composite electrodes obtained in Embodiments 6 to 10 had a metal lithium loading capacity of 5 mAh cm⁻². After the electrodes were cycled for 500 times at a current density of 1 mA cm⁻² with a cycling capacity of 1 mAh cm⁻² (i.e., having the effective utilization rate of the lithium metal of 20%), the overpotentials of the lithium metal composite electrodes obtained in Embodiments 6 to 10 could be stabilized within 76 mV, 54 mV, 66 mV, 60 mV and 58 mV respectively, and the voltage platform was stable without obvious fluctuation. The volume expansion ratio could be controlled at 6%, 3%, 4%, 5% and 4% respectively.

The SEM images of the carbon-lithium composite powder electrode obtained in the testing Embodiment 3 and a pure lithium foil after 50 cycles at a current density of 1 mA cm⁻² were compared, and the results were shown in FIG. 5, where “a” was the testing result of the carbon-lithium composite powder electrode obtained in Embodiment 3 and “b” was the testing result of the pure lithium foil. It can be seen that the lithium metal composite powder electrode supported by the carbon skeleton as provided by the present invention can effectively inhibit growth of dendrites.

It can be seen from the above test results that, the anode material obtained from the carbon-lithium composite powder of the present invention has a low overvoltage, good cycling stability, and a high effective utilization rate of the metal lithium. This is because in the present invention, the carbon-lithium composite powder is directly loaded on the current collector by roll-pressing, such that the effective capacity of the metal lithium loaded on the pole piece can be effectively regulated to improve the effective utilization rate of the metal lithium, and the high specific surface area of the internal carbon skeleton can effectively reduce the current density, regulate the lithium ions to be uniformly deposited, and stabilize the surface potential of the electrode, thereby effectively inhibiting the growth of lithium dendrites.

The results of the above Embodiments show that, the lithium metal composite powder electrode material supported by the carbon skeleton as provided by the present invention has features of effectively regulating the metal lithium loading capacity, significantly improving the utilization rate of the metal lithium, inhibiting the growth of dendrites, and the like, which has a very good guiding significance in modification of the lithium metal anode of the lithium metal secondary battery.

The method provided by the present invention is simple and controllable, and is convenient for scale production and industrialization.

### LISTING OF ACRONYMS AND ABBREVIATIONS

° C. degrees Celsius

μm micrometer

Al Aluminum

C Carbon

cm² centimeters squared

cm³ cubic centimeters

DME Ethylene glycol dimethyl ether

DOL 1,3-dioxolane

g gram

h hour

HFP hexafluoropropylene

kg kilogram

L liter

La Lanthanum

LATP Li_{1.3}Ti_{1.7}Al_{0.3}(PO₄)₃

Li Lithium

LiTFSI Bis(trifluoromethane)sulfonimide lithium salt

LiXC Lithium-carbon alloy phase

LLZO Li7La₃Zr₂O₁₂

mA milliamp

mAh milliamp hour

mg milligram

min minute

ml milliliter

mol mole

MPa Megapascal

mV millivolt

nm nanometer

O Oxygen

PET Polyethylene terephthalate

P Phosphorus

POE polyoxyethylene

PVDF poly(vinylidene fluoride)

r rotation

SEM scanning electronic microscope

Ti Titanium

V volt

Wh watt hour

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A carbon-lithium composite powder, comprising a carbon skeleton and metal lithium coated on the surface of the carbon skeleton in composition, wherein the particle size of the carbon-lithium composite powder is 500 nm to 50 μm.

2. The carbon-lithium composite powder of claim 1, wherein the mass ratio of the carbon skeleton to the metal lithium in the composite powder is (10-90):(10-90); and the components of the carbon skeleton comprise one or more of mesoporous carbon, activated carbon and graphene.

3. The carbon-lithium composite powder of claim 1, wherein the carbon skeleton further contains a doping source, and the mass of the doping source is 0.05% to 0.5% of the mass of the carbon skeleton; and the doping source is one or more of nitrogen, sulfur and phosphorus.

4. A method for preparing the carbon-lithium composite powder of claim 1, comprising the steps of:
(1) heating a mixture comprising a carbon material and metal lithium to 250-400° C., then stirring at a constant temperature, and subsequently cooling to obtain a primary coated powder, wherein the time of the constant-temperature stirring is 5-40 min, and the rotation speed of the constant-temperature stirring is 50-200 r/min; and
(2) ball milling the primary coated powder obtained in step (1) to obtain the carbon-lithium composite powder.

5. A method for preparing the carbon-lithium composite powder of claim 2, comprising the steps of:
(1) heating a mixture comprising a carbon material and metal lithium to 250-400° C., then stirring at a constant temperature, and subsequently cooling to obtain a primary coated powder, wherein the time of the constant-temperature stirring is 5-40 min, and the rotation speed of the constant-temperature stirring is 50-200 r/min; and
(2) ball milling the primary coated powder obtained in step (1) to obtain the carbon-lithium composite powder.

6. A method for preparing the carbon-lithium composite powder of claim 3, comprising the steps of:
(1) heating a mixture comprising a carbon material and metal lithium to 250-400° C., then stirring at a constant temperature, and subsequently cooling to obtain a primary coated powder, wherein the time of the constant-temperature stirring is 5-40 min, and the rotation speed of the constant-temperature stirring is 50-200 r/min; and
(2) ball milling the primary coated powder obtained in step (1) to obtain the carbon-lithium composite powder.

7. The preparation method of claim 4, wherein the ball milling time in step (2) is 0.5-2 h, and the rotation speed of the ball milling is 50-400 r/min.

8. The preparation method of claim 5, wherein the ball milling time in step (2) is 0.5-2 h, and the rotation speed of the ball milling is 50-400 r/min.

9. The preparation method of claim 6, wherein the ball milling time in step (2) is 0.5-2 h, and the rotation speed of the ball milling is 50-400 r/min.

10. The preparation method of claim 4, wherein the particle size of the carbon material in step (1) is 200 nm to 30 μm.

11. The preparation method of claim 5, wherein the particle size of the carbon material in step (1) is 200 nm to 30 μm.

12. The preparation method of claim 6, wherein the particle size of the carbon material in step (1) is 200 nm to 30 μm.

13. The preparation method of claim 4, further comprising: before mixing the carbon material with the metal lithium, performing doping modification on the carbon raw material to obtain a doped carbon material;
wherein the element used for doping modification is one or more of nitrogen, sulfur and phosphorus.

14. The preparation method of claim 5, further comprising: before mixing the carbon material with the metal lithium, performing doping modification on the carbon raw material to obtain a doped carbon material;
wherein the element used for doping modification is one or more of nitrogen, sulfur and phosphorus.

15. The preparation method of claim 6, further comprising: before mixing the carbon material with the metal lithium, performing doping modification on the carbon raw material to obtain a doped carbon material;
wherein the element used for doping modification is one or more of nitrogen, sulfur and phosphorus.

16. The preparation method of claim 10, further comprising: before mixing the carbon material with the metal lithium, performing doping modification on the carbon raw material to obtain a doped carbon material;
wherein the element used for doping modification is one or more of nitrogen, sulfur and phosphorus.

17. A method for preparing a lithium metal secondary battery electrode, comprising the steps of: coating a PET film and carbon-lithium composite powder onto the surface of a current collector in a roll-pressing manner to obtain the lithium metal secondary battery electrode; or
coating a gel electrolyte and the carbon-lithium composite powder onto the surface of the current collector in a roll-pressing manner to obtain the lithium metal secondary battery electrode.

18. The preparation method of claim 17, wherein the gel electrolyte is polyoxyethylene-bis(trifluoromethane)sulfonimide lithium, PVDF-poly(vinylidene fluoride-co-hexafluoropropylene)-Li7La₃Zr₂O₁₂, or PVDF-poly(vinylidene fluoride-co-hexafluoropropylene)-Li₁₃Ti_{1.7}Al_{0.3}(PO₄)₃; and the mass of the gel electrolyte is less than or equal to 1% of the mass of the carbon-lithium composite powder.

19. The preparation method of claim 17, wherein based on the mass of the carbon-lithium composite powder, the coating amount is 0.2-20 mg/cm².

20. The preparation method of claim 18, wherein based on the mass of the carbon-lithium composite powder, the coating amount is 0.2-20 mg/cm².
